(19) United States
(12) Patent Application Publication
(10) Pub. No.: US 2022/0243441 A1
(43) Pub. Date: Aug. 4, 2022

(54) Automatic Pressure-Activated Toilet Spray Apparatus

(71) Applicant: Eran Eyal, Kfar Sava (IL)

(72) Inventor: Eran Eyal, Kfar Sava (IL)

(21) Appl. No.: 17/569,589

(22) Filed: Jan. 6, 2022

Related U.S. Application Data
(60) Provisional application No. 63/144,542, filed on Feb. 2, 2021.

(51) Int. Cl. E03D 9/00; B05B 11/00

(52) U.S. Cl. CPC E03D 9/005; B05B 11/3056

(57) ABSTRACT

The present disclosure provides a toilet spray apparatus which operates automatically, removing the need for a user to take any actions to reduce or eliminate toilet odours, and which requires no batteries to operate, instead taking advantage of the pressure resulting from a user sitting on a toilet seat. In response to a user sitting, the apparatus will emit a vaporised spray of fluid into a toilet bowl forming a protective layer that prevents unpleasant odours from rising. The apparatus comprises a reservoir body, a spring-operated pump mechanism, an extended outlet for hooking over a toilet bowl rim, and a housing.

### CROSS REFERENCES TO RELATED APPLICATIONS

The present application claims the benefit and priority of US provisional application No. US63144542, filed 2 Feb. 2021.

### FIELD OF INVENTION

The present invention relates generally to the field of toilet fresheners. More specifically, the present invention relates to a toilet spray apparatus configured to release a spray of vapor in response to an actuation of a toilet seat.

### BACKGROUND

Many air freshener solutions have been proposed for eliminating or reducing the odors that occur in toilets and bathrooms after users have used the toilet. Air freshener sprays are often left within arm's reach of the toilets, but require a user to manually spray vapors into the surrounding air after use.

Some devices have been proposed which use sensors to detect when a user is no longer sitting on the toilet and to automatically emit a pleasant-smelling vapor in response. While such solutions are an improvement over spray cans, they are battery operated and must be checked and have the batteries replaced at regular intervals.

It is within this context that the present invention is provided.

### SUMMARY

The present disclosure provides a toilet spray apparatus which operates automatically, removing the need for a user to take any actions to reduce or eliminate toilet odours, and which requires no batteries to operate, instead taking advantage of the pressure resulting from a user sitting on a toilet seat. In response to a user sitting, the apparatus will emit a vaporised spray of fluid into a toilet bowl forming a protective layer that prevents unpleasant odours from rising. The apparatus comprises a reservoir body, a spring-operated pump mechanism, an extended outlet for hooking over a toilet bowl rim, and a housing.

Thus, according to one aspect of the present disclosure there is provided an automatic, pressure-driven toilet spray apparatus, comprising: a reservoir body for holding a fluid, the reservoir body formed of a hollow container having an opening; a pump mechanism placed over the container opening, the pump mechanism comprising a spring-operated piston having a one-way valve connected to an inlet, the inlet extending into the reservoir body; an extended spray outlet comprising an outlet tube connected to the piston of the pump mechanism and ending in a vaporising nozzle; and a housing of the pump mechanism and spray outlet forming a hook shape of the spray outlet, wherein the housing comprises a lever connected to the spray pump mechanism configured such that actuation of the lever causes the piston to draw fluid through the inlet from the reservoir body to be sprayed out of the vaporising nozzle.

In some embodiments, the one-way valve is a floating ball valve configured to prevent drawn fluid from reversing flow back to the container of the reservoir body.

In some embodiments, the lever is configured to protrude from an outer portion of the housing such that, if the hook shape of the spray outlet is hooked over the rim of a toilet bowl underneath a toilet seat, a downward motion of the toilet seat will compress the lever and cause a spray of vaporised fluid to be ejected from the apparatus.

In further embodiments, the vaporising nozzle comprises a second valve mechanism to increase fluid ejection efficiency.

In yet further embodiments, the spring of the piston causes the lever to return to its original position after an actuation.

Finally, in some embodiments, the reservoir body, inlet, piston, outlet tube, and vaporising nozzle together form an airtight sealed pathway for maximising the spray pressure caused by actuation of the lever.

### BRIEF DESCRIPTION OF THE DRAWINGS

Various embodiments of the invention are disclosed in the following detailed description and accompanying drawings.

FIG. 1 illustrates an exploded/perspective view of the various components of an example configuration of the toilet spray apparatus of the present disclosure.

FIG. 2 illustrates a cross-sectional view of the example configuration of the toilet spray apparatus of FIG. 1 with the components connected together in the intended configuration for use.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As mentioned above, the present disclosure relates to a toilet spray apparatus that operates automatically by emitting a pressurised and vaporised spray of fluid from a reservoir in response to an actuation resulting from a user sitting on a toilet seat.

The apparatus is configured to hooked over the rim of a toilet bowl, underneath a toilet seat, with the nozzle of the apparatus pointing into the toilet bowl, and has a lever which is actuated by the toilet seat when a user sits down, the lever causing a pump mechanism of the device to emit a vaporised spray.

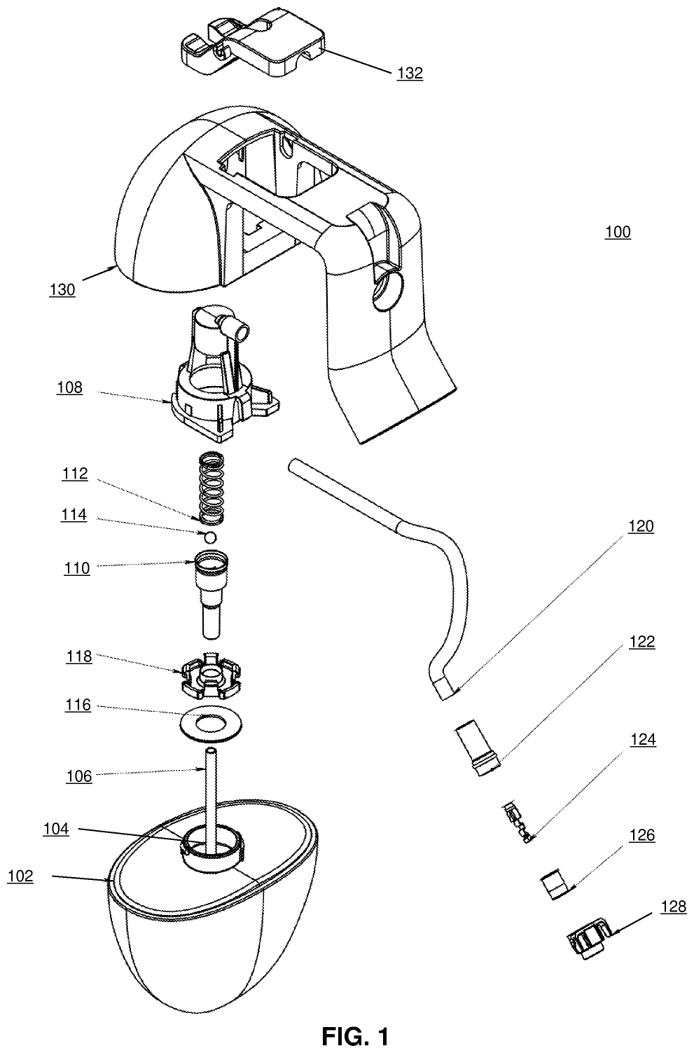

Referring to FIG. 1, an exploded/perspective view of the various components of an example configuration of the toilet spray apparatus 100 of the present disclosure is shown.

The apparatus is formed of a reservoir body 102 which h is a hollow container with an opening 104 for holding a fluid such as an air freshening fluid in liquid form. Any suitable type of formula may be used, and even fluids which are not air fresheners since the apparatus operates not only to produce pleasant odours but to form a protective layer of vapour in a toilet bowl to prevent odours from excrement and other waste from rising.

The reservoir body 102 in the present example is illustrated as rounded however any suitable shape may be used.

Covering the opening 104 of the reservoir body 102 is a pump mechanism comprised of several parts. An inlet 106 in the form of a thin tube extends down into the reservoir body 102 to draw fluid out and up to a piston-like mechanism. In the present example the piston-like mechanism is a standard pump head 108 which is set over a piston body 110 that contains a spring 112 and a one-way valve in the form of a floating ball valve 114.

The one-way valve 114 blocks fluid which has been drawn through the inlet 106 from returning to the reservoir body 102. With the ball valve this is achieved since liquid pressure inside the piston body 110 causes the floating ball to be pushed downwards against the narrower bottom end, closing the valve and blocking liquid flow from the piston to the reservoir 102. When the spray apparatus is actuated again, fluid will be drawn through the inlet 106 lifting the ball 114 back into a floating position and opening the valve.

The spring 112 is compressed when the spray apparatus is compressed, and the potential energy created by the compression will cause the components to return to their original position once the actuation has been released, allowing the apparatus 100 to reset itself automatically after a spray of fluid has been ejected, i.e. when the user has stood back up after using a toilet upon which the apparatus 100 is mounted.

The pump mechanism may be connected to the reservoir body 102 via one or more washers 116 and cap elements 118, which act to keep the connected between the components sealed and airtight for better fluid pressure management. These are optional features of the illustrated design.

Connected to the pump head 108 is an extended outlet 120 in the form of a long curved tube which directs pumped fluid drawn from the reservoir 102 over the rim of the toilet bowl and out of a nozzle/atomiser assembly which vaporises the fluid for ejection into the toilet bowl.

In the illustrated example the nozzle/atomiser assembly is formed of a housing 122, a valve 124, a sleeve for the valve 126, and an atomiser 128. This is a standard valve assembly design and is merely used herein as an illustrative suitable configuration. Other nozzle/atomiser assemblies and configurations may also be used.

The pump mechanism, extended outlet, and nozzle/atomising assembly are all held within an outer housing 130 which acts both to protect the internal components and ensure the fluid pathways are not broken, and to provide structural integrity to the apparatus 100 as a whole such that it can be hooked over the rim of a toilet bowl as intended.

Furthermore, the housing 130 comprises a movable lever 132 which protrudes from the outer surface of the housing to provide a point of interaction between a toilet seat of a toilet upon which the apparatus is mounted and the pump mechanism, such that downward movement of the toilet seat which occurs when a users sits on it causes actuation of the lever 132 and consequently compresses the pump mechanism causing fluid to be drawn from the reservoir 102 and ejected from the nozzle assembly in an atomised spray directed into the toilet bowl before a user uses the toilet.

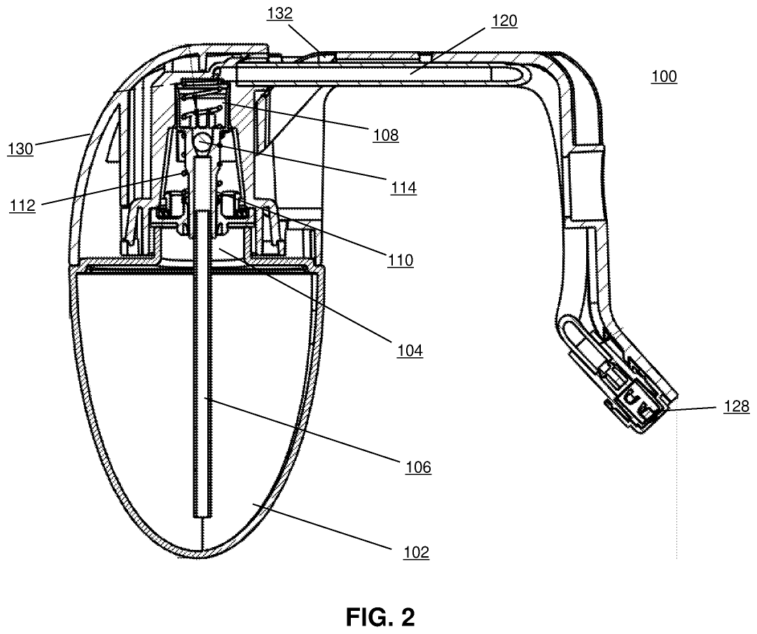

Referring to FIG. 2, a cross-sectional view of the example configuration of the toilet spray apparatus 100 is shown with the components connected together in the intended configuration for use.

As can be seen, the extended outlet and housing form a hooked shape that conveniently allow for placement over the rim of a toilet bowl such that the atomiser/nozzle assembly point directly into the toilet bowl of a toilet on which the apparatus 100 is mounted.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system for providing a virtual event space coordinated with a real world event space have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An automatic, pressure-driven toilet spray apparatus, comprising:
a reservoir body for holding a fluid, the reservoir body formed of a hollow container having an opening;
a pump mechanism placed over the container opening, the pump mechanism comprising a spring-operated piston having a one-way valve connected to an inlet, the inlet extending into the reservoir body;
an extended spray outlet comprising an outlet tube connected to the piston of the pump mechanism and ending in a vaporising nozzle; and
a housing of the pump mechanism and spray outlet forming a hook shape of the spray outlet, wherein the housing comprises a lever connected to the spray pump mechanism configured such that actuation of the lever causes the piston to draw fluid through the inlet from the reservoir body to be sprayed out of the vaporising nozzle.

2. A toilet spray apparatus according to claim 1, wherein the one-way valve is a floating ball valve configured to prevent drawn fluid from reversing flow back to the container of the reservoir body.

3. A toilet spray apparatus according to claim 1, wherein the lever is configured to protrude from an outer portion of the housing such that, if the hook shape of the spray outlet is hooked over the rim of a toilet bowl underneath a toilet seat, a downward motion of the toilet seat will compress the lever and cause a spray of vaporised fluid to be ejected from the apparatus.

4. A toilet spray apparatus according to claim 1, wherein the vaporising nozzle comprises a second valve mechanism to increase fluid ejection efficiency.

5. A toilet spray according to claim 1, wherein the spring of the piston causes the lever to return to its original position after an actuation.

6. A toilet mechanism according to claim 1, wherein the reservoir body, inlet, piston, outlet tube, and vaporising nozzle together form an airtight sealed pathway for maximising the spray pressure caused by actuation of the lever.
